(19) United States
(12) Patent Application Publication
(10) Pub. No.: US 2022/0007297 A1
(43) Pub. Date: Jan. 6, 2022

(54) DATA TRANSMISSION METHOD, SENDING TERMINAL DEVICE, AND RECEIVING TERMINAL DEVICE

(71) Applicants: CHINA MOBILE COMMUNICATION CO., LTD RESEARCH INSTITUTE, Beijing (CN); CHINA MOBILE COMMUNICATION GROUP CO., LTD., Beijing (CN)

(72) Inventors: Yi ZHENG, Beijing (CN); Dan WU, Beijing (CN); Jing DONG, Beijing (CN); Xueying HOU, Beijing (CN)

(21) Appl. No.: 17/291,695

(22) PCT Filed: Nov. 8, 2019
(86) PCT No.: PCT/CN2019/116544

§ 371 Date: May 6, 2021

(30) Foreign Application Priority Data
Nov. 9, 2018 (CN) 201811331140.1

(51) Int. Cl. H04W 52/14; H04W 52/36; H04W 88/14

(52) U.S. Cl. CPC H04W 52/143; H04W 88/14; H04W 52/367

(57) ABSTRACT

The present invention provides a data transmission method, a sending terminal device, and a receiving terminal device. The data transmission method corresponding to the sending terminal device comprises: configuring a transmit power by using a power control parameter of the receiving terminal device, wherein in the case where the sending terminal device is a base station, the receiving terminal device is an integrated access and backhaul (IAB) apparatus, and in the case where the sending terminal device is a parent IAM apparatus, the receiving terminal device is a child IAB apparatus; and transmitting a downlink service by using the configured transmit power.

### CROSS-REFERENCE TO RELATED APPLICATION

This application claims priority to Chinese Patent Application No. 201811331140.1 filed in China on Nov. 9, 2018, which is incorporated herein by reference in its entirety.

### TECHNICAL FIELD

The present disclosure relates to the technical field of communications, and more particularly, to a method for data transmission, a transmitting device, and a receiving device.

### BACKGROUND

With the development of communication technologies, the self-backhaul technology is introduced in the 3rd Generation Partnership Project (3GPP). The resource allocation modes in the self-backhaul technology may be classified into a time division multiplexing (TDM) mode, a frequency division multiplexing (IDM) mode, and a space division multiplexing (SDM) mode, which are shown in FIG. 1a, FIG. 1b, and FIG. 1c respectively.

FIG. 1d is a schematic diagram of two operation modes for TDM between an access link and a backhaul link. For example, the child integrated access and backhaul (IAB) device 2 does not communicate with the UE3 served by the Child-IAB device 2 when the Child-IAB device 2 communicates with the base station 1. The Child-IAB device 2 does not communicate with the base station 1 when the Child-IAB device 2 communicates with the served UE 3. That is, merely one of the two links works at a time.

In order to achieve the full utilization of resources, in the introduced FDM and SDM transmission modes, as shown in FIG. 1e, the Child-IAB device 2 may communicate with the base station 1 and the served UE3 simultaneously. Compared with the TDM transmission mode, the FDM and SDM transmission modes improve the operation efficiency of the system and reduce the delay to some extent.

That is, with the SDM or FDM transmission mode, the Child-IAB device may simultaneously receive signals from the UE and the upper-level Child-IAB device, i.e., the Parent-IAB device (P-IAB device). According to the downlink transmission modes in the related art, the Parent-IAB device may adopt a downlink transmission mode with full power or constant power, and the UE may adopt a transmission mode based on power control. Thus, the arrival power in the uplink is much less than the arrival power from the base station in the downlink, which causes the signal of the user equipment to be blocked, and consequently, the signal transmitted by the user equipment cannot be received by the base station.

### SUMMARY

The objective of the present disclosure is to provide a method for data transmission, a transmitting device, and a receiving device, so as to solve a problem that a signal of a user equipment is blocked, causing a signal transmitted by the user equipment cannot be received by a base station.

To achieve the above-mentioned objective, in a first aspect, the present disclosure provides a method for data transmission, applied to a transmitting device. The transmitting device is a base station or a parent Integrated Access and Backhaul (IAB) device. The method for data transmission includes:

configuring a transmit power by using a power control parameter of a receiving device; when the transmitting device is a base station, the receiving device is an IAB device, or when the transmitting device is a Parent-IAB device, the receiving device is a Child-IAB device; and

transmitting a downlink service with the configured transmit power.

In a second aspect, the present disclosure further provides another method for data transmission, applied to a receiving device. The receiving device is an Integrated Access and Backhaul (IAB) device or a Child-IAB device. The method for data transmission includes:

transmitting a power control parameter; the power control parameter is used for a transmitting device to configure a transmit power for transmitting a downlink service to the receiving device.

In a third aspect, the present disclosure further provides a transmitting device. The transmitting device is a base station or a parent Integrated Access and Backhaul (IAB) device. The transmitting device includes a processor and a first transceiver.

The processor is arranged to configure a transmit power by using a power control parameter of a receiving device; when the transmitting device is the base station, the receiving device is an IAB device, or when the transmitting device is a Parent-IAB device, the receiving device is a Child-IAB device.

The first transceiver is arranged to transmit a downlink service with the configured transmit power.

In a fourth aspect, the present disclosure further provides a receiving device. The receiving device is an Integrated Access and Backhaul (IAB) device or a Child-IAB device. The receiving device includes a second transceiver arranged to:

transmit a power control parameter; wherein the power control parameter is used for a transmitting device to configure a transmit power for transmitting a downlink service to the receiving device.

In a fifth aspect, the present disclosure further provides a transmitting device. The transmitting device includes a memory, a processor, and a computer program stored in the memory and executable on the processor. The processor, when executing the program, implements the method for data transmission corresponding to the transmitting device provided in the present disclosure.

In a sixth aspect, the present disclosure further provides a receiving device. The receiving device includes a memory, a processor, and a computer program stored on the memory and executable on the processor. The processor, when executing the program, implements the method for data transmission corresponding to the receiving device provided in the present disclosure.

In a seventh aspect, the present disclosure further provides a computer readable storage medium having stored thereon a computer program which, when executed by a processor, implements the steps of the method for data transmission corresponding to the transmitting device provided in the present disclosure.

In an eighth aspect, the present disclosure further provides another computer readable storage medium having stored thereon a computer program which, when executed by a processor, implements the steps of the method for data transmission corresponding to the receiving device provided in the present disclosure.

The above-mentioned technical solution of the present disclosure has at least the following beneficial effects.

The transmitting device can configure the transmit power by using the power control parameter of the receiving device, and transmit the service with the configured transmit power, thereby reducing the arrival power during the transmitting device transmits the service, and preventing the signal transmitted by the user equipment from being blocked.

### BRIEF DESCRIPTION OF THE DRAWINGS

FIG. 1a-FIG. 1c are schematic diagrams of resource allocation in the TDM, FDM and SDM transmission modes, respectively.

FIG. 1d is a schematic diagram corresponding to a TDM transmission mode.

FIG. 1e is a schematic diagram corresponding to the FDM or SDM transmission mode.

FIG. 2a is a flowchart of a method for data transmission by a transmitting device according to some embodiments of the present disclosure.

FIG. 2b is a schematic diagram of a service transmission mode according to some embodiments of the present disclosure.

FIG. 2c is a schematic diagram of receiving power by a receiving device according to some embodiments of the present disclosure.

FIG. 3 is a flowchart of a method for data transmission by a receiving device according to some embodiments of the present disclosure.

FIG. 4 is a structure diagram of a transmitting device according to some embodiments of the present disclosure.

FIG. 5 is a structure diagram of a receiving device according to some embodiments of the present disclosure.

FIG. 6 is another structure diagram of a transmitting device according to some embodiments of the present disclosure.

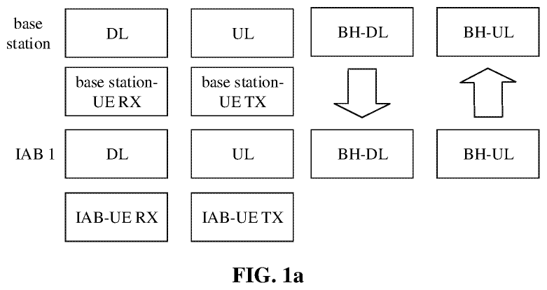

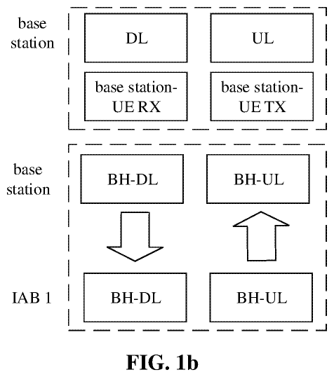

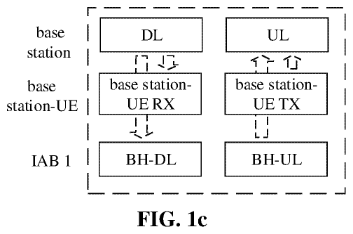

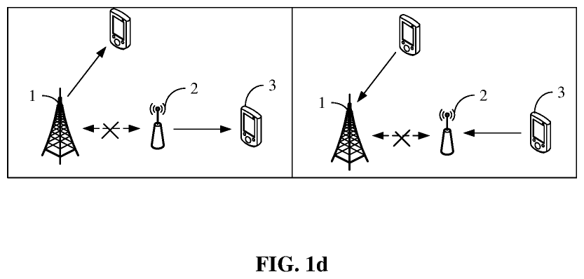

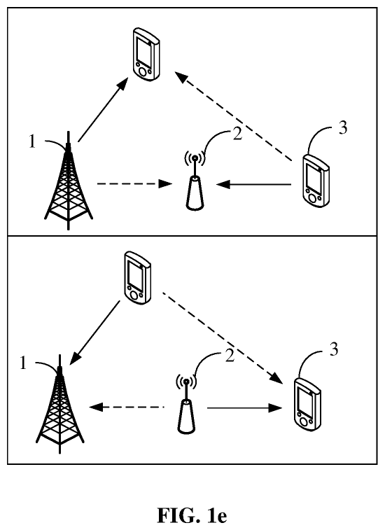

### DETAILED DESCRIPTION

In order to make the technical problems to be solved, technical solutions, and advantages of the present disclosure clearer, reference are made in detail to the accompanying drawings and specific examples.

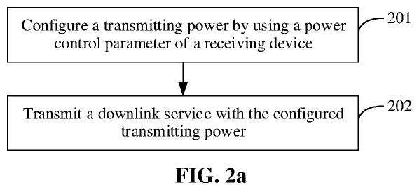

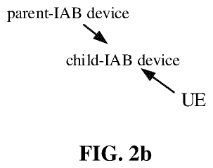

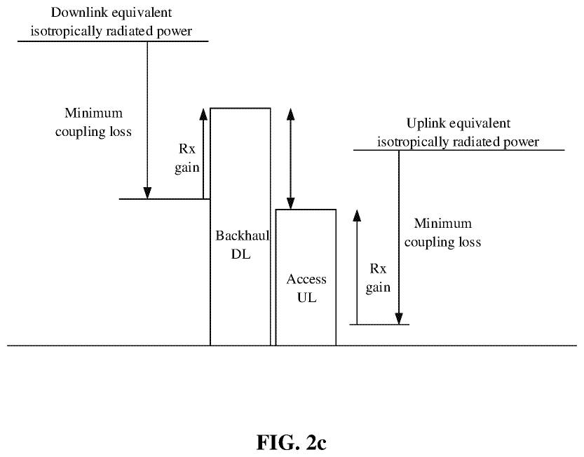

Referring to FIG. 2a, FIG. 2a is a flowchart of a method for data transmission according to some embodiments of the present disclosure. As shown in FIG. 2a, the method for data transmission is applied to a transmitting device, and includes Steps 201 and 202.

In 201, transmit power is configured by using a power control parameter of a receiving device. When the transmitting device is a base station, the receiving device is an IAB device, or when the transmitting device is a Parent-IAB device, the receiving device is a Child-IAB device.

Herein, the Child-IAB device may be a child node of a Parent-IAB device (P-IAB device for short), and the Parent-IAB device may be a base station or an intermediate node between the base station and the Child-IAB device.

The case where the transmitting device is a Parent-IAB device, and the receiving device is a Child-IAB device is taken for example. As shown in FIG. 2b, FIG. 2b is a schematic diagram of the transmission modes based on FDM and SDM. The Child-IAB device may receive signals transmitted by the P-IAB device and signals transmitted by the UE at the same time. In the related art, as shown in FIG. 2c, the P-IAB device generally employs a downlink transmission mode with full power or constant power, and the UE employs a transmission mode based on power control. In the transmission process, there may be power loss, radiation, or the like, and the final arrival power in the uplink is much less than the final arrival power of the P-IAB device in the downlink. With the method for data transmission of some embodiments of the present disclosure, the transmit power of the P-IAB device may be controlled, such that the difference value between the arrival power of the user equipment in the uplink and the arrival power of the P-IAB device in the downlink are within a certain range, thereby reducing the possibility that the signal of the user equipment is blocked.

In this step, the power control parameter may be information for controlling the transmit power when the transmitting device transmits the downlink service to the receiving device.

The power control parameter includes at least one of: a P0 parameter, an alpha parameter, a target receiving power parameter Pᵣₓ, a power spectral density parameter P_{tx_psd, limit}, or a transmit power limit parameter P_{tx, limit}.

Herein, the P0 parameter represents the target arrival power of the receiving device configured for the current cell.

The alpha parameter represents a partial path loss compensation factor.

The transmitting device may configure the transmit power based on the above-mentioned power control parameter. Furthermore, the limit value of the transmit power and of the arrival power of the transmitting device may be obtained based on the above-mentioned parameters in combination with parameters such as a path loss of power transmission. In this embodiment, the value of the transmit power may be quickly obtained based on the above-mentioned parameters, thereby improving the efficiency for data processing.

Optionally, the power control parameter is an indicated power adjustment value or a target power value.

In this embodiment, the transmit power may be adjusted in a closed-loop power control mode or in an open-loop power control mode.

Herein, the closed-loop power control mode may be a mode in which the calculated transmit power is adjusted, and the receiving device may receive the indicated power adjustment value transmitted by another device. In this way, the receiving device may compare the downlink transmit power of the transmitting device with the uplink transmit power of the user equipment to determine whether it is necessary to adjust the transmit power of the transmitting device, and may transmit the adjusted value to the transmitting device.

For example, the P-IAB device calculates the downlink transmit power (Transmission Power, TXP) according to the target receiving power reported by the Child-IAB device, or the P0 parameter, together with the Reference Signal Receiving Power (RSRP) reported by the Child-IAB device. The Child-IAB device determines whether to adjust the transmit power of the P-IAB device based on the receiving power of the P-IAB device and the uplink receiving power of the user currently served, and transmits the adjustment information Q if the adjustment is required. The P-IAB device adjusts, according to the adjustment information received from the Child-IAB device, the TXP correspondingly, by increasing the TXP by X db or decreasing the TXP by X db.

The open-loop power control mode may be such that the transmit power is adjusted to the target power value (the target power value may be calculated according to the above-mentioned parameters, or may be determined directly by the IAB according to the uplink arrival power of the UE). For example, the Child-IAB device transmits the target power value to the P-IAB device, and the P-IAB device adjusts the transmit power to the target power value when performing data transmission with the Child-IAB device.

The indicated power adjustment value or the target power value may be carried in a Transmission Power control (TPC) command The TPC command may be a power control control command added based on an uplink control channel or a service channel For example, when a service transmission is included, power control indication information is added to uplink feedback information corresponding to the service transmission; or when non-service scheduling transmission is performed, a partial TPC command is included on the Physical Uplink Shared Channel (PUSCH).

When the transmitting device receives the power control parameter transmitted by the receiving device, the transmitting device may adjust the transmit power according to the power control parameter. Furthermore, the transmitting device may communicate with the receiving device to determine whether the adjustment of power is needed and to determine the power adjustment value.

For example, when the P-IAB device performs downlink transmission at a certain power TXP, the Child-IAB device determines whether the downlink power of the P-IAB device needs to be adjusted based on the received power and the uplink arrival powers of other UEs. If the adjustment is needed, the Child-IAB device carries the adjustment information Q in the corresponding downlink Hybrid Automatic Repeat request-ACKnowledgement (HARQ-ACK) information or the PUSCH information, and transmits the adjustment information Q to the P-IAB device. The P-IAB device adjusts the downlink transmit power according to the received adjustment value, for example, by increasing the downlink transmit power by X dB, or decreasing the downlink transmit power by X dB, or directly adjusting the downlink transmit power to the indicated target power value.

In this embodiment, the transmitting device may adjust the transmit power based on the above-mentioned power control modes, and may switch between full power and non-full power by controlling the downlink transmit power , so as to ensure that the arrival power level of the transmitting device is substantially equal to the arrival power level of the UE, thereby solving the problem of signal blocking.

Optionally, before the transmit power is configured by using the power control parameter of the receiving device, the method further includes:

receiving the power control parameter reported by the receiving device; or

receiving the power control parameter carried in higher layer signaling.

In this embodiment, the above-mentioned power control parameter may be reported by the receiving device or carried in higher layer signaling. The flexibility in obtaining the power control parameter, the efficiency in sending the power control parameter, and the data transmission performance may be improved through obtaining the power control parameter in the above-mentioned multiple manners.

In 202, a downlink service is transmitted with the configured transmit power.

In this step, the transmitting device may transmit the downlink service according to the configured transmit power. Since the transmit power is obtained according to the power control parameter of the receiving device, it may ensure that the arrival power of the transmitting device when the downlink service is transmitted is substantially equal to the arrival power of the transmission signal in the uplink service performed by the user equipment, thereby solving the problem that the signal transmitted by the user equipment is blocked.

Optionally, transmitting the downlink service with the configured transmit power specifically includes:

transmitting the downlink service on a target resource with the configured transmit power, and transmitting the downlink service on a resource other than the target resource with a power or a power spectral density configured by a system.

Herein, the target resource is predetermined by a protocol, or is configured by a central control node or a system (such as a network management system), or is configured autonomously by the transmitting device, or is configured at a network side through radio resource control (RRC) signaling, is indicated by a medium access control control element (MAC CE), or is indicated at a network side through physical layer signaling.

In this embodiment, the transmitting device and the receiving device may adopt different transmit powers when performing communication with different resources.

Furthermore, the transmitting device may transmit data in the above-mentioned power control mode only when communicating with the target resource. The target resource may be a time-frequency resource. For example, the P-IAB device adopts the above-mentioned power control modes only on the time-frequency resource 1, and adopts the transmission mode of full power or constant power spectrum on the time-frequency resource 2, where the full power or constant power spectrum may be the transmission mode in which the P-IAB device performs transmission with the downlink power spectral density.

For resources other than the target resource, the power or power spectral density configured by the system may be used for downlink service transmission. The value of transmit power may be measured in energies per resource element (EPRE) for the downlink service transmission with the power spectral density.

The target resource may be configured in a semi-static manner, and may indicate a corresponding transmission time slot based on the RRC configuration, such that the P-IAB device adopts the corresponding power at the corresponding time slot for control.

The target resource may be configured by signaling-based indication. For example, the target resource may be configured based on the RRC or the MAC CE, or may be configured by triggering of Physical Uplink Control Channel (PUCCH) or PUSCH of the Child-IAB device. The PUSCH may carry signaling such as the MAC CE to indicate a specific time-frequency resource to be used, and the PUCCH may use signaling of a physical layer to indicate a time-frequency resource for subsequent power control transmission.

In this embodiment, the target resource for communication between the transmitting device and the receiving device is defined, such that different power control modes may be adopted for different communication resources, thereby improving the flexibility and efficiency in data transmission. When the transmitting device transmits a downlink service to the receiving device, and the user equipment transmits an uplink service to the receiving device at the same time, the data transmission may be performed in the above-mentioned modes, such that the transmit power of the transmitting device may be reduced, and the possibility that the user equipment is blocked may be reduced.

Specifically, the transmit power P1 configured in the above-mentioned manner is less than the maximum allowable transmit power Pcmax configured by the system.

In this way, the system may pre-configure the maximum allowable transmit power value, so as to limit the transmit power in the downlink service transmission of the transmitting device through the maximum allowable transmit power value.

Furthermore, the configured transmit power P1 is one of a second power P2, a third power P3, a fourth power P4, a fifth power P5, and a sixth power P6; wherein

P2=P0+10*log10(M)+PL+Auxiliary parameter;

P3=P0 +10*log10(M)+α*PL+Auxiliary parameter;

P₄=Pᵣₓ+10*log10(M)+PL+Auxiliary parameter;

P₅=P_{tx, limit}+Auxiliary parameter; and

P₆ =P_{tx_psd, limit}+10*log10(M)+Auxiliary parameter.

In the above-mentioned calculation formulas, the Child-IAB device and the P-IAB device are used as examples when calculating the second power P2. The cell configuration user Po parameter reported by the Child-IAB device may be acquired, and the propagation loss PL from the P-IAB device to the Child-IAB device may be acquired according to the Reference Signal Receiving Power (RSRP) reported by the function of the user equipment served by the Child-IAB device. Based on the above-mentioned parameters, the downlink transmit power may be calculated according to the above-mentioned calculation formulas.

When the P-IAB device needs to perform the transmission with multiple Child-IAB devices, each Child-IAB device needs to report the respective uplink power control parameters used by the cell, such as P₀, alpha, and RSRP. The P-IAB device selects the parameters P₀, alpha, and RSRP corresponding to each Child-IAB device according to the cell for downlink transmission, and calculates the corresponding transmit power.

If the Child-IAB device reports the parameter a while reporting the above-mentioned parameters, the transmit power may be calculated according to the calculation formula for the third power.

In the above-mentioned calculation manners, the fourth power P4 may be a power value that limits the arrival power of the transmitting device; and the fifth power P5 may be a power value that limits the transmit power of the transmitting device.

Herein, for the calculation formula of the fifth power P5, if the Child-IAB device reports the maximum allowable arrival power Px of the cell, the Child-IAB device estimates the available transmit power, that is, the fifth power, based on the currently configured transmit power and the propagation loss. Herein, Px is calculated according to the target value P₀ which is set for the uplink receiving power of the current cell of the receiving device.

When the P-IAB device covers multiple Child-IAB device nodes, the power may be configured according to the power parameters such as {Px}, {Px, PL}, or {Px, RSRP} reported by each Child-IAB device, and may be transmitted with the power parameters reported by the corresponding Child-IAB device during the transmission.

In the above-mentioned calculation formulas for P2 to P6, M represents the number of physical resource blocks (PRBs) occupied by the downlink transmission.

PL represents the measured path loss on the reference signal.

P0 represents the target arrival power of the cell configuration.

ΔTF represents an adjustment parameter associated with a transmission format, e.g., a power adjustment value based on a Modulation and Coding Scheme (MCS).

The auxiliary parameters include at least one of the adjustment parameter ATF associated with the transmission format or the power adjustment parameter.

Herein, the auxiliary parameter may be any one of ΔTF or the power adjustment parameter, and when the auxiliary parameter includes both the parameters, the auxiliary parameter may be a sum of ΔTF and the power adjustment parameter.

In this embodiment, a transmit power value may be obtained according to any one of the above-mentioned calculation formulas, and data transmission may be performed according to the transmit power value. In comparison with the fixed transmit power, the downlink transmit power of the transmitting device may be prevented from being excessively high, and it may be ensured that the arrival power of the transmitting device and the arrival power of the user equipment are at an equivalent level, thereby preventing the signal of the user equipment from being blocked.

According to the method for data transmission of some embodiments of the present disclosure, the transmitting device may determine a target transmit power according to a power control parameter transmitted by the receiving device, and perform the transmission according to the target transmit power, thereby reducing the transmit power of the transmitting device and preventing the signal transmitted by the user equipment from being blocked.

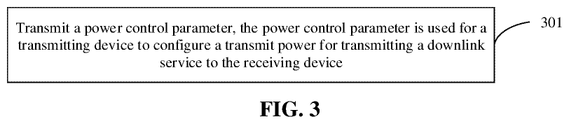

Referring to FIG. 3, FIG. 3 is a flowchart of a method for data transmission according to some embodiments of the present disclosure. The method is applied to a receiving device which is an Integrated Access and Backhaul IAB device or a Child-IAB device. The method is implemented from the perspective of the receiving device among the methods for data transmission described above. As shown in FIG. 3, the method includes Step 301.

In 301, a power control parameter is transmitted; herein the power control parameter is used for a transmitting device to configure transmit power for transmitting a downlink service to the receiving device.

In this step, the transmitting device may determine the transmit power for transmitting the downlink service to the receiving device according to the power control parameter. Since the transmit power is determined according to the power control parameter transmitted by the receiving device, it may ensure that the arrival power of the transmitting device during the service transmission is substantially equal to the arrival power of the signal transmitted by the user equipment, thereby solving the problem that the signal transmitted by the user equipment is blocked.

Herein, the power control parameter includes at least one of: a P0 parameter, an alpha parameter, a target receiving power parameter Pᵣₓ, a power spectral density parameter or a transmit power limit parameter P_{tx, limit}.

The explanation for the above-mentioned parameters and the beneficial effects of the embodiment may be found in the description of the above-mentioned embodiments.

Optionally, the power control parameter is an indicated power adjustment value or a target power value.

The explanation and beneficial effects of the embodiment may be found in the description of the above-mentioned embodiments.

Optionally, the power control parameter is reported based on physical layer information of the receiving device, or is configured by a medium access control control element MAC CE or through radio resource control RRC signaling.

Since the power control parameter may be acquired based on the above-mentioned multiple modes, the efficiency of information acquisition may be improved.

According to the method for data transmission of some embodiments of the present disclosure, the receiving device transmits the power control parameter to the transmitting device, such that the transmitting device uses a target transmit power when communicating with the receiving device. In this way, it may ensure that the arrival power of the transmitting device when performing the service transmission is substantially equal to the arrival power of the signal transmitted by the user equipment, thereby solving the problem that the signal transmitted by the user equipment is blocked due to the too large difference between the arrival power of the transmitting device and the arrival power of the user equipment.

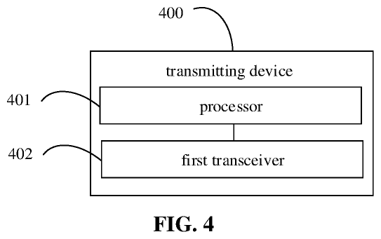

Referring to FIG. 4, some embodiments of the present disclosure provide a transmitting device. The transmitting device 400 is a base station or a parent Integrated Access and Backhaul IAB device. As shown in FIG. 4, the transmitting device 400 includes a processor 401 and a first transceiver 402.

The processor 401 is arranged to configure transmit power by using a power control parameter of a receiving device; when the transmitting device is the base station, the receiving device is an IAB device, or when the transmitting device is a Parent-IAB device, the receiving device is a Child-IAB device.

The first transceiver 402 is arranged to transmit a downlink service with the configured transmit power.

Optionally, the first transceiver 402 is specifically arranged to:

transmit the downlink service on a target resource, with the configured transmit power, and transmit the downlink service on a resource other than the target resource with a power or with a power spectral density configured by a system.

Optionally, the target resource is predetermined by a protocol, or is configured by a central control node or a system, or is configured autonomously by the transmitting device, or is configured at a network side through radio resource control RRC signaling, or is indicated by a medium access control control element MAC CE, or is indicated at a network side through physical layer signaling.

Optionally, the first transceiver 402 is further arranged to:

receive the power control parameter reported by the receiving device, before the processor 401 configures the transmit power by using the power control parameter of the receiving device; or

receive the power control parameter carried in higher layer signaling, before the processor 401 configures the transmit power by using the power control parameter of the receiving device.

Optionally, the power control parameter includes at least one of: a P0 parameter, an alpha parameter, a target receiving power parameter Prx, a power spectral density parameter P_{tx_psd, limit} or a transmit power limit parameter P_{tx, limit}.

Optionally, the configured transmit power P1 is less than the maximum allowable transmit power Pcmax configured by a system.

Optionally, the configured transmit power P1 is one of a second power P2, a third power P3, a fourth power P4, a fifth power P5, and a sixth power P6; wherein

P2=P0+10*log 10(M)+PL+Auxiliary parameter;

P3=P0+10*log 10(M)+α*PL+Auxiliary parameter;

P₄=Pᵣₓ+10*log10(M)+PL+Auxiliary parameter;

P₅=P_{tx, limit}+Auxiliary parameter; and

P₆=P_{tx_psd, limit}+10*log(M)+Auxiliary parameter.

Optionally, the auxiliary parameter includes at least one of an adjustment parameter ΔTF associated with a transmission format or a power adjustment parameter.

Optionally, the power control parameter is an indicated power adjustment value or a target power value.

It is to be noted that, in some embodiments of the present disclosure, the transmitting device 400 may be the transmitting device of any implementation in the embodiment of the present disclosure shown in FIG. 2. Any implementation in the embodiment of the present disclosure shown in FIG. 2 may be achieved by the transmitting device 400 in this embodiment, and the same beneficial effects may be generated, of which the details are not described herein.

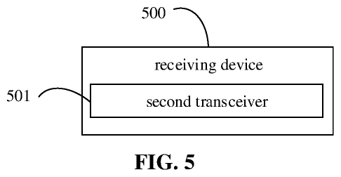

Referring to FIG. 5, some embodiments of the present disclosure provide a receiving device. The receiving device is an Integrated Access and Backhaul IAB device or a Child-IAB device. As shown in FIG. 5, the receiving device 500 includes a second transceiver 501 arranged to:

transmit a power control parameter; wherein the power control parameter is used for a transmitting device to configure transmit power for transmitting a downlink service to the receiving device.

Optionally, the power control parameter includes at least one of: a P0 parameter, an alpha parameter, a target receiving power parameter Prx, a power spectral density parameter P_{tx_psd, limit} or a transmit power limit parameter P_{tx, limit}.

Optionally, the power control parameter is an indicated power adjustment value or a target power value.

Optionally, the power control parameter is reported based on physical layer information of the receiving device, or is configured by a medium access control control element MAC CE or through radio resource control RRC signaling.

It is to be noted that, in some embodiments of the present disclosure, the receiving device 500 may be the receiving device of any implementation in the embodiment of the present disclosure shown in FIG. 3. Any implementation in the embodiment of the present invention shown in FIG. 3 may be achieved by the receiving device 500 in the embodiment, and the same beneficial effects may be generated, of which the details are not described herein.

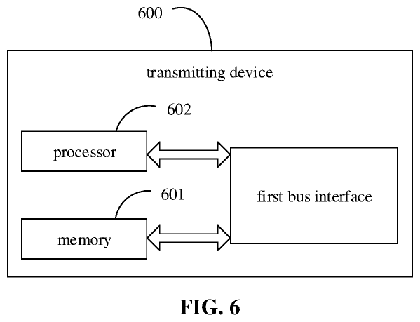

Referring to FIG. 6, another transmitting device is provided in some embodiments of the present disclosure. As shown in FIG. 6, the device at at the transmitting end 600 includes a memory 601, a processor 602, and a computer program stored on the memory 601 and executable on the processor 602. The processor 602, when executing the program, performs the following actions:

configuring transmit power by using a power control parameter of a receiving device; wherein when the transmitting device is a base station, the receiving device is an IAB device, or when the transmitting device is a Parent-IAB device, the receiving device is a Child-IAB device; and

transmitting a downlink service with the configured transmit power.

In FIG. 6, the bus architecture may include any number of interconnected bus and bridges, and specifically links together various circuits such as one or more processors represented by the processor 602 and memory represented by the memory 601. The bus architecture may further link various other circuits, such as peripherals, voltage regulators, and power management circuits, all of which are well known in the art and therefore are not be described further herein. The bus interface provides an interface. The processor 602 is responsible for managing the bus architecture and general processing, and the memory 601 may store data used by the processor 602 in performing the operations.

Optionally, the processor 602 performs the transmission of a downlink service with the configured transmit power specifically as follows:

transmitting the downlink service on a target resource with the configured transmit power, and transmitting the downlink service on a resource other than the target resource with a power or with a power spectral density configured by a system.

Optionally, the target resource is predetermined by a protocol, or is configured by a central control node or a system, or is configured autonomously by the transmitting device, or is configured at a network side through radio resource control RRC signaling, or is indicated by a medium access control control element MAC CE, or is indicated at a network side through physical layer signaling.

Optionally, the processor 602 is further arranged to:

receiving the power control parameter reported by the receiving device, before configuring the transmit power by using the power control parameter of the receiving device; or

receiving the power control parameter carried in higher layer signaling, before configuring the transmit power through the power control parameter of the receiving device.

Optionally, the power control parameter includes at least one of: a P0 parameter, an alpha parameter, a target receiving power parameter Pᵣₓ, a power spectral density parameter P_{tx_psd, limit}, or a transmit power limit parameter P_{tx, limit}.

Optionally, the configured transmit power P1 is less than the maximum allowable transmit power Pcmax configured by a system.

Optionally, the configured transmit power P1 is one of a second power P2, a third power P3, a fourth power P4, a fifth power P5, and a sixth power P6; wherein

P2=P0+10*log10(M)+PL+Auxiliary parameter;

P3=P0+10*log10(M)+α*PL+Auxiliary parameter;

P₄=Pᵣₓ+10*log10(M)+PL+Auxiliary parameter;

P₅=P_{tx, limit}+Auxiliary parameter; and

P₆=P_{tx_psd, limit}+10*log10(M)+Auxiliary parameter.

Optionally, the auxiliary parameter comprises at least one of an adjustment parameter ΔTF associated with a transmission format or a power adjustment parameter.

Optionally, the power control parameter is an indicated power adjustment value or a target power value.

It is to be noted that, in some embodiments of the present disclosure, the transmitting device 600 may be the transmitting device of any implementation in the embodiment of the present disclosure shown in FIG. 2. Any implementation in the embodiment of the present disclosure shown in FIG. 2 may be achieved by the transmitting device 600 in the embodiment, and the same beneficial effects may be generated, of which details are not described herein.

When the above-mentioned device is a receiving device, the structure of the receiving device may be shown in FIG. 6. The receiving device includes a memory 601, a processor 602, and a computer program stored on the memory 601 and executable on the processor 602. The processor 602, when executing the program, performs the following actions:

transmitting a power control parameter; wherein the power control parameter is used for a transmitting device to configure a transmit power for transmitting a downlink service to the receiving device.

Optionally, the power control parameter comprises at least one of a P0 parameter, an alpha parameter, a target receiving power parameter Pᵣₓ, a power spectral density parameter P_{tx_psd, limit} or a transmit power limit parameter P_{tx, limit}.

Optionally, the power control parameter is an indicated power adjustment value or a target power value.

Optionally, the power control parameter is reported based on physical layer information of the receiving device, or is configured by a medium access control control element (MAC CE) or through radio resource control (RRC) signaling.

It is to be noted that, in some embodiments of the present disclosure, the receiving device may be the receiving device of any implementation in the embodiment of the present disclosure shown in FIG. 3. Any implementation in the embodiment of the present disclosure shown in FIG. 3 may be achieved by the receiving device in the embodiment, and the same beneficial effects may be generated, of which details are not described herein.

Some embodiments of the present disclosure further provide a computer readable storage medium having a computer program stored thereon. The computer program, when executed by a processor, implements the processes of the above-described methods for data transmission and achieves the same technical effects. To avoid repetition, details are not described herein. The computer readable storage medium includes a Read-Only Memory (ROM), a Random Access Memory (RAM), a magnetic disk, an optical disk, or the like.

In the several embodiments provided herein, it is to be understood that the disclosed methods and devices may be implemented in other ways. For example, the device embodiments described above are merely illustrative. For example, the partitioning of the unit is merely the partitioning of logical functions, and may be implemented in another manner for the partitioning. For example, multiple units or components may be combined or integrated into another system, or some features may be ignored or not performed. On the other hand, the coupling, direct coupling or communication connection therebetween shown or discussed may be implemented through some interfaces, and the indirect coupling or communication connection between devices or units may be in the form of electric, mechanic or the like.

In addition, the functional units in the embodiments of the present disclosure may be integrated in one processing unit, may be individually and physically included in each unit, or may be integrated in one unit having two or more units. The integrated unit may be implemented in the form of hardware or in the form of hardware plus software functional units.

The integrated unit implemented as a software functional unit may be stored in a computer readable storage medium. The software functional unit is stored in a storage medium and includes instructions for causing a computer device (which may be a personal computer, a server, a network device, or the like) to perform some of the steps of the transmitting and receiving methods described in the embodiments of the present disclosure. The storage medium includes a USB flash drive, a removable hard disk, a Read-Only Memory (ROM), a Random Access Memory (RAM), a magnetic disk, or an optical disk.

The foregoing are optional embodiments of the present disclosure. It is to be noted that several modifications and embellishments may be made by those of ordinary skill in the art without departing from the principles set forth herein, and such modifications and embellishments also fall within the scope of the present disclosure.

1. A method for data transmission, applied to a transmitting device, the transmitting device being a base station or a parent integrated access and backhaul (IAB) device, the method for data transmission comprising:
configuring a transmit power by using a power control parameter of a receiving device, wherein when the transmitting device is a base station, the receiving device is an IAB device; or when the transmitting device is a Parent-IAB device, the receiving device is a Child-IAB device; and
transmitting a downlink service with the configured transmit power.

2. The method for data transmission according to claim 1, wherein transmitting the downlink service with the configured transmit power comprises:
transmitting the downlink service on a target resource with the configured transmit power, and
transmitting the downlink service on a resource other than the target resource with a power or with a power spectral density configured by a system.

3. The method for data transmission according to claim 2, wherein the target resource is predetermined by a protocol, or is configured by a central control node or the system, or is configured autonomously by the transmitting device, or is configured at a network side through radio resource control (RRC) signaling, or is indicated by a medium access control control element (MAC CE), or is indicated at a network side through physical layer signaling.

4. The method for data transmission according to claim 1, wherein before configuring the transmit power by using the power control parameter of the receiving device, the method further comprises:
receiving the power control parameter reported by the receiving device; or
receiving the power control parameter carried in higher layer signaling.

5. The method for data transmission according to claim 4, wherein the power control parameter comprises at least one of: a P0 parameter, an alpha parameter, a target receiving power parameter Pᵣₓ, a power spectral density parameter P_{tx_psd, limit}, or a transmit power limit parameter P_{tx, limit}.

6. The method for data transmission according to claim 5, wherein the configured transmit power P1 is less than a maximum allowable transmit power Pcmax configured by a system.

7. The method for data transmission according to claim 6, wherein the configured transmit power P1 is one of a second power P2, a third power P3, a fourth power P4, a fifth power P5, or a sixth power P6; wherein
P2=P0+10*log10(M)+PL+Auxiliary parameter.
P3=P0+10*log10(M)+α*PL+Auxiliary parameter;
P₄=Pᵣₓ+10*log 10(M)+PL+Auxiliary parameter;
P₅=P_{tx, limit}+Auxiliary parameter; and
P₆=P_{tx_psd, limit}+10*log10(M)+Auxiliary parameter.

8. The method for data transmission according to claim 7, wherein the auxiliary parameter comprises at least one of an adjustment parameter ΔTF associated with a transmission format or a power adjustment parameter.

9. The method for data transmission according to claim 1, wherein the power control parameter is an indicated power adjustment value or a target power value.

10. A method for data transmission, applied to a receiving device, the receiving device being an Integrated Access and Backhaul (IAB) device or a Child-IAB device, the method for data transmission comprising:
transmitting a power control parameter; wherein the power control parameter is used for a transmitting device to configure a transmit power for transmitting a downlink service to the receiving device.

11. The method for data transmission according to claim 10, wherein the power control parameter comprises at least one of a P0 parameter, an alpha parameter, a target receiving power parameter Pᵣₓ, a power spectral density parameter P_{tx_psd, limit}, or a transmit power limit parameter P_{tx, limit}.

12. The method for data transmission according to claim 10, wherein the power control parameter is an indicated power adjustment value or a target power value.

13. The method for data transmission according to claim 10, wherein the power control parameter is reported based on physical layer information of the receiving device, or is configured by a medium access control control element (MAC CE) or through radio resource control (RRC) signaling.

14. A transmitting device, the transmitting device being a base station or a parent integrated access and backhaul (IAB) device, the transmitting device comprising a processor and a first transceiver; wherein
the processor is arranged to configure transmit power by using a power control parameter of a receiving device; wherein when the transmitting device is the base station, the receiving device is an IAB device, or when the transmitting device is a Parent-IAB device, the receiving device is a Child-IAB device; and
the first transceiver is arranged to transmit a downlink service with the configured transmit power.

15. The transmitting device according to claim 14, wherein the first transceiver is arranged to:
transmit the downlink service on a target resource with the configured transmit power, and transmit the downlink service on a resource other than the target resource with a power or with a power spectral density configured by a system.

16. The transmitting device according to claim 15, wherein the target resource is predetermined by a protocol, or is configured by a central control node or the system, or is configured autonomously by the transmitting device, or is configured at a network side through radio resource control RRC signaling, or is indicated by a medium access control control element (MAC CE), or is indicated at a network side through physical layer signaling.

17. The transmitting device according to claim 14, wherein before the processor configures the transmit power by using the power control parameter of the receiving device, the first transceiver is further arranged to:
receive the power control parameter reported by the receiving device; or
receive the power control parameter carried in higher layer signaling.

18. The transmitting device of claim 17, wherein the power control parameter comprises at least one of a P0 parameter, an alpha parameter, a target receiving power parameter Prx, a power spectral density parameter P_{tx_psd, limit}, or a transmit power limit parameter P_{tx, limit}.

19. The transmitting device of claim 18, wherein the configured transmit power P1 is less than a maximum allowable transmit power Pcmax configured by a system.

20. The transmitting device of claim 19, wherein the configured transmit power P1 is one of a second power P2, a third power P3, a fourth power P4, a fifth power P5, or a sixth power P6; wherein
P2=P+10*log10(M)+PL+Auxiliary parameter;
P3=P0+10*log10(M)+α*PL+Auxiliary parameter;
P₄=Pᵣₓ+10*log10(M)+PL+Auxiliary parameter;
P₅=P_{tx, limit}+Auxiliary parameter; and
P₆=P_{tx_psd, limit}+10*log10(M)+Auxiliary parameter.

21. The transmitting device of claim 20, wherein the auxiliary parameter comprises at least one of an adjustment parameter ΔTF associated with a transmission format or a power adjustment parameter.

22. The transmitting device according to claim 14, wherein the power control parameter is an indicated power adjustment value or a target power value.

23. A receiving device, the receiving device being an integrated access and backhaul (IAB) device or a Child-IAB device, the receiving device comprising a second transceiver arranged to:
transmit a power control parameter; wherein the power control parameter is used for a transmitting device to configure a transmit power for transmitting a downlink service to the receiving device.

24. The receiving device of claim 23, wherein the power control parameter comprises at least one of a P0 parameter, an alpha parameter, a target receiving power parameter Pᵣₓ, a power spectral density parameter P_{tx_psd, limit} or a transmit power limit parameter P_{tx, limit}.

25. The receiving device of claim 23, wherein the power control parameter is an indicated power adjustment value or a target power value.

26. The receiving device according to claim 23, wherein the power control parameter is reported based on physical layer information of the receiving device, or is configured by a medium access control control element (MAC CE) or through radio resource control (RRC) signaling.

27-29. (canceled)
